(19) United States
(12) Patent Application Publication
(10) Pub. No.: US 2005/0251312 A1
(43) Pub. Date: Nov. 10, 2005

(54) Self-propelled cleaner

(75) Inventor: Takao Tani, Osaka (JP)

Correspondence Address: Yokoi & Co., U.S.A., Inc., 13700 Marina Pointe Drive #1512, Marina Del Rey, CA, 90292, US

(73) Assignee: Funai Electric Co., Ltd., Osaka (JP)

(21) Appl. No.: 11/105,256

(22) Filed: Apr. 13, 2005

(30) Foreign Application Priority Data
Apr. 15, 2004 (JP) JP2004-120580

(51) Int. Cl. G05D 1/00

(52) U.S. Cl. 701/41

(57) ABSTRACT

For a self-propelled cleaner, it is costly and substantially unfeasible to provide a user interface which enables the user to specify a position because it requires a complicated structure. In this invention, while traveling around a room for cleaning, a cleaner generates map information (S400-S422) and, near a marker, adds positional data from the marker to map information. Since such markers identify the locations of automatic locks as special positions 1 to 4, positional data on automatic locks are easily included in the map information. In a lock fastening/unfastening control process, the system judges whether it has received a lock fastening/unfastening instruction (S440 and S442) and extracts fastening/unfastening information (S444) and moves along a travel route to a specified lock location (S450) and sends a fastening/unfastening signal in response to a received instruction (S452). Thus, the user outside can easily specify the location of an automatic lock and give an instruction to fasten or unfasten it.

### BACKGROUND OF THE INVENTION

1. Field of the Invention

This invention relates to a self-propelled cleaner comprising a body with a cleaning mechanism and a drive mechanism capable of steering and driving the cleaner.

2. Description of the Prior Art

Robots which fasten or unfasten a lock installed in a house according to an instruction from outside as disclosed in JP-A No. 254372/2002 and JP-A No. 281653/2003 have been known.

The above conventional robots can automatically move to a position for fastening or unfastening the lock and fasten or unfasten it. However, nothing is disclosed about how to specify a position for fastening/unfastening the lock. Generally, a user interface which enables the user to specify a position, which requires a complicated structure, has been costly and thus difficult to realize.

### SUMMARY OF THE INVENTION

This invention has been made in view of the abovementioned problem and provides a self-propelled cleaner that is capable of cleaning while traveling by self-propulsion and can also be used to store data on positions for fastening or unfastening locks sequentially utilizing its self-propelling capability.

According to one aspect of the invention, a self-propelled cleaner has a body with a cleaning mechanism, and a drive mechanism capable of steering and driving the cleaner. It includes:
a mapping processor which generates and stores map information on a room during traveling around the room by self-propulsion, and acquires, from a marker installed in a given place in the room which outputs positional data on a previously specified location, the positional data and adds it to the map information;
a wireless LAN communication device which can transmit given information to the outside and receive given information from the outside through a wireless LAN;
a remote control processor which can transmit a remote operation signal to a remotely controllable lock which is installed at the location specified by the positional data from the marker and can be fastened or unfastened according to the remote operation signal; a travel route calculation processor which calculates a travel route from the present position to the above specified location; and a lock fastening/unfastening control processor which, upon receipt of a lock fastening/unfastening command for the remotely controllable lock from outside through the wireless LAN, makes the travel route calculation processor calculate a travel route and controls the drive mechanism so as to move the cleaner along the travel route, and makes the remote control processor transmit a received lock fastening/unfastening remote operation signal at the specified location.

The system constructed as above has a drive mechanism capable of steering and driving the cleaner and thus the cleaner body can perform cleaning while traveling by self-propulsion. During traveling around the room by self-propulsion, the mapping processor generates and stores map information on the room to be cleaned and acquires, from the marker installed in a given place in the room which outputs positional data on a previously specified location, the positional data and adds it to the map information. One such special position is the location of a remotely controllable lock which can be fastened or unfastened according to a remote operation signal and the above map information includes data on the location of the remotely controllable lock. Since the travel route calculation processor calculates a travel route from the present position to the above specified location, obviously it can calculate a travel route from the present position to the location of the above remotely controllable lock. In addition, the lock fastening/unfastening control processor can receive a lock fastening/unfastening command for the remotely controllable lock from outside through the wireless LAN; when it receives such a command, it makes the travel route calculation processor calculate a travel route and controls the drive mechanism so as to move the cleaner along the travel route, and makes the remote control processor transmit the received lock fastening/unfastening remote operation signal at the specified location.

In other words, when a cleaner with an inherent self-propelling cleaning capability is combined with a marker as mentioned above, it can easily acquire data on the location of a remotely controllable lock and move the cleaner body to that location by remote control to fasten or unfasten the lock.

Even if the user forgot to fasten the lock, he/she can easily fasten it from a remote location or unfasten it from a remote location to allow a given person to enter the room.

Since communication with a remote location is done through a network based on a wireless LAN, the system can be easily accessed via a modern mobile phone unit and is feasible at a very low cost.

The type of remotely controllable lock to which the invention can be applied is not limited. In one example, the remotely controllable lock is a front door lock and the marker is located on a front door and outputs positional data as a position for fastening or unfastening the lock, and the lock fastening/unfastening control processor makes the remote control processor fasten or unfasten the front door lock.

In another example, the remotely controllable lock is an external window lock and the marker is located on an external window and outputs positional data as a position for fastening or unfastening the lock, and the lock fastening/unfastening control processor makes the remote control processor fasten or unfasten the external window lock. Therefore, the invention may be preferably embodied for front door locks or external windows.

In another preferred embodiment, the remotely controllable lock is installed on each of an external window and an inner door in a given room and the lock fastening/unfastening control processor, upon detection of an intruder in the room, fasten the remotely controllable locks to lock the external window and inner door.

In the system constructed as above, if there is an intruder in the room, the external window and the inner door will be locked with the above remotely controllable locks and the intruder can be kept in confinement until the police arrives.

In this case, there is the risk that the intruder might destroy the self-propelled cleaner and go out of the room. According to another aspect of the invention, the lock fastening/unfastening control processor can control the drive mechanism so as for the cleaner to perform a predetermined escape motion. Therefore, if an intruder is encaged, the cleaner performs a predetermined escape motion to eliminate the risk of its destruction by the intruder.

The cleaning mechanism incorporated in the body may be of the suction-type or brush-type or combination-type.

The drive mechanism capable of steering and driving the cleaner enables the cleaner to go forward or backward, or turn to the right (clockwise) or to the left (counterclockwise), or spin on the same spot by controlling individually the drive wheels provided at the right and left sides of the body. In this case, auxiliary wheels may be provided, for example, before and behind the drive wheels. Furthermore, endless belts may be used instead of drive wheels. The number of wheels in the drive mechanism is not limited to two; it may be four, six or more.

As one concrete example of the above system, according to another aspect of the invention, a self-propelled cleaner has a body with a cleaning mechanism and a drive mechanism with drive wheels at the left and right sides of the body whose rotation can be individually controlled for steering and driving the cleaner. It includes: a mapping processor which acquires and stores map information on a room to be cleaned during traveling around the room for cleaning it and acquires positional data on the location of a remotely controllable lock from a marker installed in a given place in the room which outputs positional data on a previously specified location, and adds it to the map information; a wireless LAN communication device which can transmit given information to the outside and receive given information from the outside through a wireless LAN; a remote control processor which can transmit remote operation signals to remotely controllable locks, installed on a front door, an external window and an inner door as special positions stored in the mapping processor through the marker, which can be fastened or unfastened according to the remote operation signals; a travel route calculation processor which calculates a travel route from the present position to the above specified locations; and a lock fastening/unfastening control processor which, upon receipt of a lock fastening/unfastening command for the remotely controllable locks from outside through the wireless LAN, makes the travel route calculation processor calculate a travel route and controls the drive mechanism so as to move the cleaner along the travel route, and makes the remote control processor transmit a received lock fastening/unfastening remote operation signal at the specified location.

In the system constructed as above, the mapping processor acquires and stores map information on the room to be cleaned during traveling around the room for cleaning it and acquires positional data on the location of a remotely controllable lock from a marker installed in a given place in the room which outputs positional data on a previously specified location, and adds it to the map information. The remote control processor can transmit remote operation signals to remotely controllable locks, installed on a front door, an external window and an inner door, which can be fastened or unfastened according to the remote operation signals. The travel route calculation processor calculates a travel route from the present position to the above specified locations. When the lock fastening/unfastening control processor receives a lock fastening/unfastening command for the remotely controllable locks from outside through the wireless LAN, it makes the travel route calculation processor calculate a travel route and controls the drive mechanism so as to move the cleaner along the travel route, and makes the remote control processor transmit a received lock fastening/unfastening remote operation signal at the specified location.

As described above, since the system acquires positional data from the marker and adds it to the map information while traveling around by self-propulsion, positional data on a specific location can be set very easily through the marker and it is possible to identify the location of a specific remotely controllable lock and remotely control it from outside.

### BRIEF DESCRIPTION OF THE DRAWINGS

FIG. 1 is a block diagram schematically showing the construction of a self-propelled cleaner according to this invention;

FIG. 2 is a more detailed block diagram of the self-propelled cleaner;

FIG. 3 is a block diagram of an AF passive sensor unit;

FIG. 4 illustrates the position of a floor relative to the AF passive sensor unit and how ranging distance changes when the AF passive sensor unit is oriented downward obliquely toward the floor;

FIG. 5 illustrates the ranging distance in the imaging range when an AF passive sensor for the immediate vicinity is oriented downward obliquely toward the floor;

FIG. 6 illustrates the positions and ranging distances of individual AF passive sensors;

FIG. 7 is a flowchart showing a traveling control process;

FIG. 8 is a flowchart showing a cleaning traveling process;

FIG. 9 shows a travel route in a room;

FIG. 10 shows the composition of an optional unit;

FIG. 11 shows the external appearance of a marker;

FIG. 12 is a flowchart showing a mapping process;

FIG. 13 illustrates how mapping is done;

FIG. 14 illustrates how map information on each room is linked after mapping;

FIG. 15 is a plan view showing the locations of automatic locks as special positions in a room;

FIG. 16 is a flowchart showing a locking/unlocking control process; and

FIG. 17 is a flowchart showing a security mode process.

### DESCRIPTION OF THE PREFERRED EMBODIMENTS

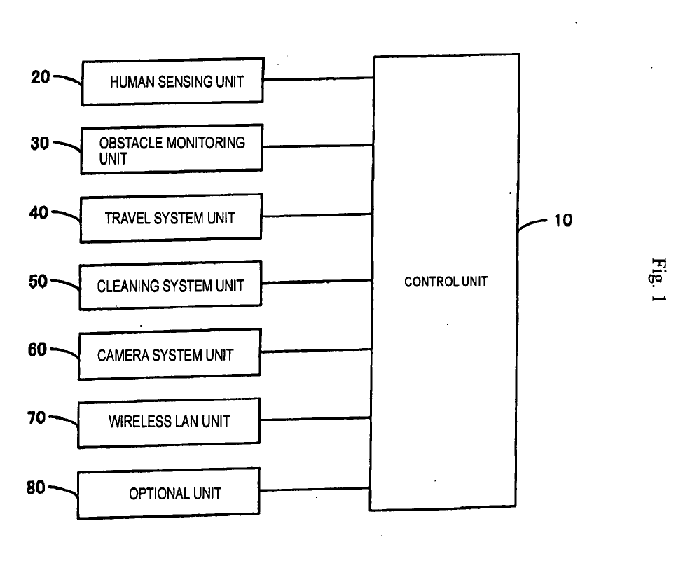

As shown in FIG. 1, according to this invention, the cleaner includes a control unit 10 to control individual units; a human sensing unit 20 to detect a human or humans around the cleaner; an obstacle monitoring unit 30 to detect an obstacle or obstacles around the cleaner; a traveling system unit 40 for traveling; a cleaning system unit 50 for cleaning; a camera system unit 60 to take a photo of a given area; a wireless LAN unit 70 for wireless connection to a LAN; and an optional unit 80 including an additional sensor and the like. The body of the cleaner has a low profile and is almost cylindrical.

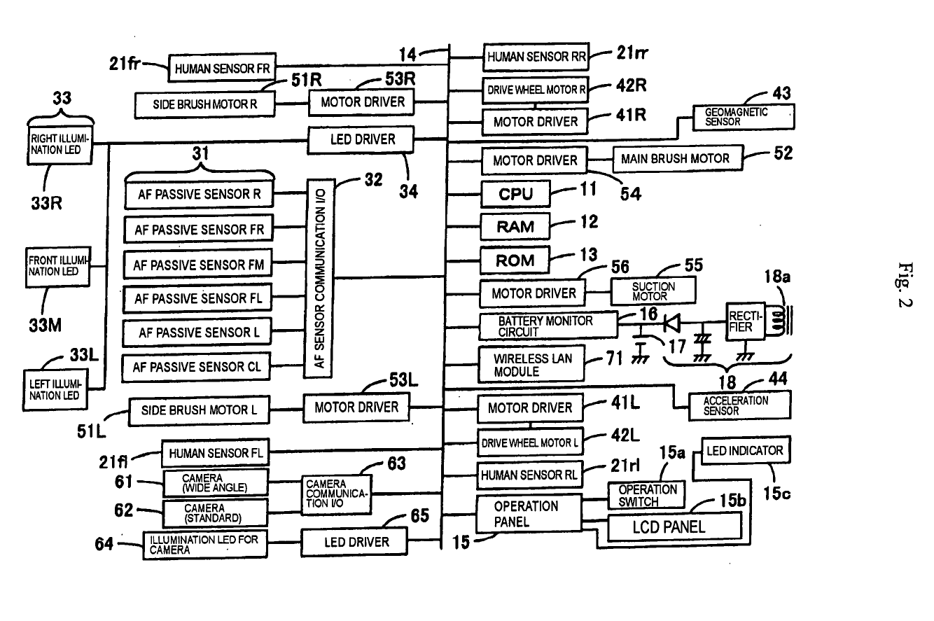

As shown in FIG. 2, a block diagram showing the electrical system configuration for the individual units, a CPU 11, a ROM 13, and a RAM 12 are interconnected via a bus 14 to constitute a control unit 10. The CPU 11 performs various control tasks using the RAM 12 as a work area according to a control program stored in the ROM 13 and various parameter tables. The control program will be described later in detail.

The bus 14 is equipped with an operation panel 15 on which various types of operation switches 15a, a liquid crystal display panel 15b, and LED indicators 15c are provided. Although the liquid crystal display panel is a monochrome liquid crystal panel with a multi-tone display function, a color liquid crystal panel or the like may also be used.

This self-propelled cleaner has a battery 17 and allows the CPU 11 to monitor the remaining amount of the battery 17 through a battery monitor circuit 16. The battery 17 is equipped with a charge circuit 18 that charges the battery with electric power supplied in a non-contact manner through an induction coil 18a. The battery monitor circuit 16 mainly monitors the voltage of the battery 17 to detect its remaining amount.

The human sensing unit 20 consists of four human sensors 21 (21fr, 21rr, 21fl, 21rl), two of which are disposed obliquely at the left and right sides of the front of the body and the other two at the left and right sides of the rear of the body. Each human sensor 21 has an infrared light-receiving sensor that detects the presence of a human body based on the amount of infrared light received. When the human sensor detects an irradiated object which changes the amount of infrared light received, the CPU 11 obtains the result of detection by the human sensor 21 via the bus 14 to change the status for output. In other words, the CPU 11 obtains the status of each of the human sensors 21fr, 21rr, 21fl, and 21rl at each predetermined time and detects the presence of a human body in front of the human sensor 21fr, 21rr, 21fl, or 21rl by a change in the status.

Although the human sensors described above detect the presence of a human body based on changes in the amount of infrared light, the human sensors are not limited to this type. For example, if the CPU's processing capability is increased, it is possible to take a color image of a target area, identify a skin-colored area that is characteristic of a human body and detect the presence of a human body based on the size of the area and/or change.

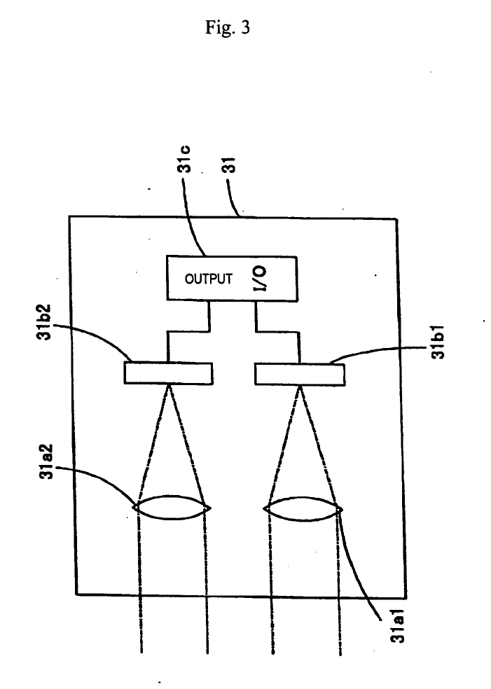

The obstacle monitoring unit 30 consists of a passive sensor unit 31 composed of ranging sensors for auto focus (hereinafter called AF) (31R, 31FR, 31EM, 31FL, 31L, 31CL); an AF sensor communication I/O 32 as a communication interface to the passive sensor unit 31; illumination LEDs 33; and an LED driver 34 to supply driving current to each LED. First, the construction of the AF passive sensor unit 31 will be described. FIG. 3 schematically shows the construction of the AF passive sensor unit 31. It includes a biaxial optical system consisting of almost parallel optical systems 31a1 and 31a2; CCD line sensors 31b1 and 31b2 disposed approximately in the image focus positions of the optical systems 31a1 and 31a2 respectively; and an output I/O 31c to output image data taken by each of the CCD line sensors 31b1 and 31b2 to the outside.

The CCD line sensors 31b1 and 31b2 each have a CCD sensor with 160 to 170 pixels and can output 8-bit data representing the amount of light for each pixel. Since the optical system is biaxial, the discrepancy between two formed images varies depending on the distance, which means that it is possible to measure a distance based on a difference between data from the CCD line sensors 31b1 and 31b2. As the distance decreases, the discrepancy between formed images increases, and vice versa. Therefore, an actual distance is determined by scanning data rows (4-5 pixels/row) in output image data, finding the difference between the address of an original data row and that of a discovered data row, and then referencing a difference-to-distance conversion table prepared in advance.

The AF passive sensors 31FR, 31FM, and 31FL are used to detect an obstacle in front of the cleaner while the AF passive sensors 31R and 31L are used to detect an obstacle on the right or left ahead in the immediate vicinity. The AF passive sensor 31CL is used to detect a distance up to the ceiling ahead.

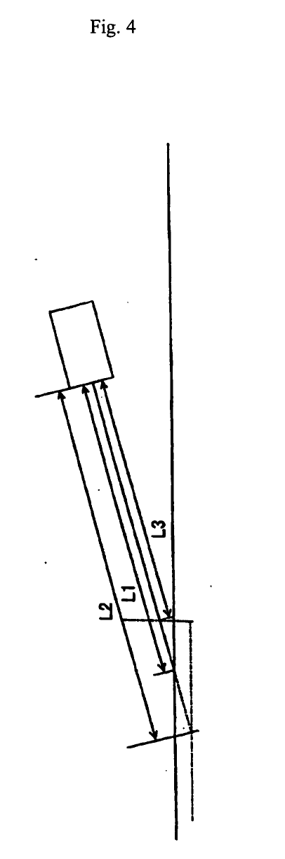

FIG. 4 shows the principle under which the AF passive sensor unit 31 detects an obstacle in front of the cleaner or on the immediate right or left ahead. The AF passive sensor unit 31 is oriented obliquely toward the surrounding floor surface. If there is no obstacle on the opposite side, the ranging distance covered by the AF passive sensor unit 31 in the almost whole imaging range is expressed by L1. However, if there is a step or floor level difference as indicated by alternate long and short dash line in the figure, the ranging distance is expressed by L2. Namely, an increase in the ranging distance suggests the presence of a step. If there is a floor level rise as indicated by alternate long and two dashes line, the ranging distance is expressed by L3. If there is an obstacle, the ranging distance is calculated as the distance to the obstacle as when there is a floor level rise, and it is shorter than the distance to the floor.

In this embodiment, when the AF passive sensor unit 31 is oriented obliquely toward the floor surface ahead, its imaging range is approx. 10 cm. Since this self-propelled cleaner has a width of 30 cm, the three AF passive sensors 31FR, 31FM and 31FL are arranged at slightly different angles so that their imaging ranges do not overlap. This arrangement allows the three AF passive sensors 31FR, 31FM and 31FL to detect an obstacle or step in a 30 cm wide area ahead of the cleaner. The detection area width varies depending on the sensor model and position, and the number of sensors should be determined according to the actually required detection area width.

Regarding the AF passive sensors 31R and 31L which detect an obstacle on the immediate right and left ahead, their imaging ranges are vertically oblique to the floor surface. The AF passive sensor 31R is mounted at the left side of the body so that a rightward area beyond the width of the body is shot across the center of the body from the immediate right and the AF passive sensor 31L is mounted at the right side of the body so that a leftward area beyond the width of the body is shot across the center of the body from the immediate left.

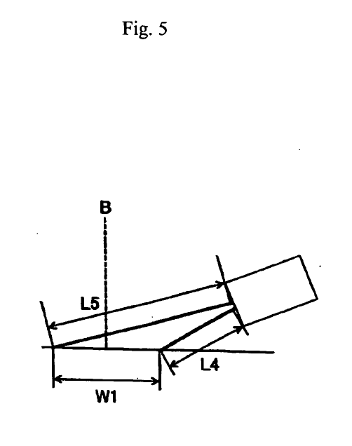

If the left and right sensors should be located so as to cover the leftward and rightward areas just before them respectively, they would have to be sharply angled with respect to the floor surface and the imaging range would be very narrow. As a consequence, more than one sensor would be needed on each side. For this reason, it is arranged that the left sensor covers the rightward area and the right sensor covers the leftward area in order to obtain a wider imaging range with a smaller number of sensors. The CCD line sensors are arranged vertically so that the imaging range is vertically oblique, and as shown in FIG. 5, the imaging range width is expressed by W1. Here, L4, distance to the floor surface on the right of the imaging range, is short and L5, distance to the floor surface on the left, is long. The imaging range portion up to the border line is used to detect a step or the like and the imaging range portion beyond the border line is used to detect a wall, where the border line of the body side is expressed by dashed line B in the figure.

The AF passive sensor 31CL, which detects a distance to the ceiling ahead, faces the ceiling. Usually, the distance from the floor surface to the ceiling which is detected by the AF passive sensor 31CL is constant but as it comes closer to a wall surface, it covers not the ceiling but the wall surface and the ranging distance becomes shorter. Hence, the presence of a wall can be detected more accurately.

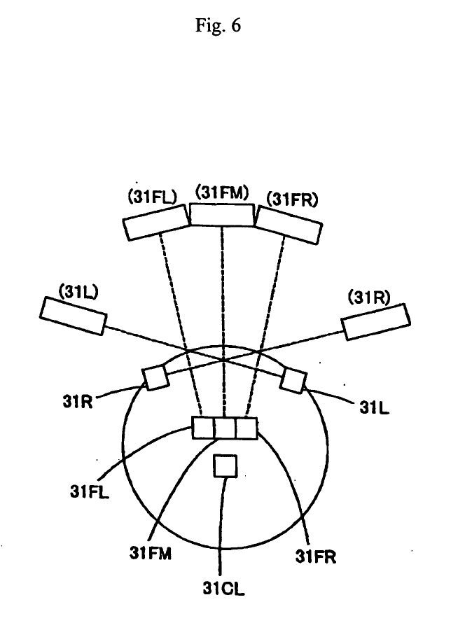

FIG. 6 shows how the AF passive sensors 31R, 31FR, 31FM, 31FL, 31L and 31CL are located on the body BD where the respective floor imaging ranges covered by the sensors are represented by the corresponding code numbers in parentheses. The ceiling imaging range is omitted here.

The cleaner has the following white LEDs: a right illumination LED 33R, a left illumination LED 33L and a front illumination LED 33M to illuminate the images from the AF passive sensors 31R, 31FR, 31M, 31FL and 31L; and an LED driver 34 supplies a driving current to illuminate the images according to an instruction from the CPU 11. Therefore, even at night or in a dark place (under the table, etc), it is possible to acquire image data from the AF passive sensor unit 31 effectively.

The traveling system unit 40 includes: motor drivers 41R, 41L; drive wheel motors 42R, 42L; and a gear unit (not shown) and drive wheels driven by the drive wheel motors 42R and 42L. A drive wheel is provided on each side (right and left) of the body. In addition, a free rolling wheel without a drive source is attached to the center bottom of the front side of the body. The rotation direction and angle of the drive wheel motors 42R and 42L can be accurately controlled by the motor drivers 41R and 41L which output drive signals according to an instruction from the CPU 11. From output of rotary encoders integral with the drive wheel motors 42R and 42L, the actual drive wheel rotation direction and angle can be accurately detected. Alternatively, the rotary encoders may not be directly connected with the drive wheels but a driven wheel which can rotate freely may be located near a drive wheel so that the actual amount of rotation can be detected by feedback of the amount of rotation of the driven wheel even if the drive wheel slips. The traveling system unit 40 also has a geomagnetic sensor 43 so that the traveling direction can be determined according to the geomagnetism. An acceleration sensor 44 detects the acceleration velocity in the X, Y and Z directions and outputs the detection result.

The gear unit and drive wheels may be embodied in any form and they may use circular rubber tires or endless belts.

The cleaning mechanism of the self-propelled cleaner consists of: side brushes located forward at both sides which gather dust beside each side of the body in the advance direction and bring the gathered dust toward the center of the body; a main brush which scoops the gathered dust in the center; and a suction fan which takes the dust scooped by the main brush into a dust box by suction. The cleaning system unit 50 consists of: side brush motors 51R and 51L and a main brush motor 52; motor drivers 53R, 53L and 54 for supplying driving power to the motors; a suction motor 55 for driving the suction fan; and a motor driver 56 for supplying driving power to the suction motor. The CPU 11 appropriately controls cleaning operation with the side brushes and main brush depending on the floor condition and battery condition or a user instruction.

The camera system unit 60 has two CMOS cameras 61 and 62 with different viewing angles which are mounted on the front side of the body at different angles of elevation. A camera communication I/O 63 which gives the camera 61 or 62 an instruction to take a photo and outputs the photo image. In addition, it has a camera illumination LED array 64 composed of 15 white LEDs oriented toward the direction in which the cameras 61 and 62 take photos, and an LED driver 65 for supplying driving power to the LEDs.

The wireless LAN unit 70 has a wireless LAN module 71 so that the CPU 11 can be connected with an external LAN wirelessly in accordance with a prescribed protocol. The wireless LAN module 71 assumes the presence of an access point (not shown) and the access point should be connectable with an external wide area network (for example, the Internet) through a router. Therefore, ordinary mail transmission and reception through the Internet and access to websites are possible. The wireless LAN module 71 is composed of a standardized card slot and a standardized wireless LAN card to be connected with the slot. Needless to say the card slot may be connected with another type of standardized card. In this embodiment, the system can transmit and receive an e-mail through the Internet and thus when a person outside sends an e-mail to the system, it receives the e-mail through the Internet and wireless LAN. The system decodes the e-mail data and, if the data includes a lock fastening/unfastening command, executes the command.

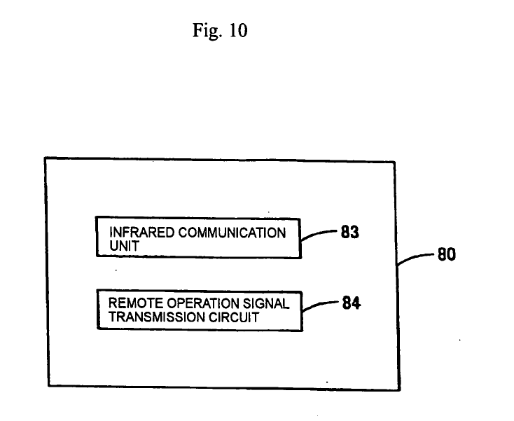

The optional unit 80 may include additional sensors and as shown in FIG. 10, in this embodiment, it has an infrared communication unit 83 and a remote operation signal transmission circuit 84. The infrared communication unit 83 can receive an infrared signal as encoded positional data sent from a marker (stated later) and decode the positional data and send it to the CPU 11.

The remote operation signal transmission circuit 84 sends a remotely controllable automatic lock, installed on a front door, an external window or an inner door, a command for fastening or unfastening it. Basically, the body moves to the vicinity of the automatic lock before the circuit transmits a command signal. In this case, the transmitted signal is non-directional. If it is an infrared signal, the system may have a means to specify which area to be irradiated or spin the body 360 degrees for transmission of such a signal. If it is an electric wave signal, the circuit usually transmits a lock fastening/unfastening command only to a specific automatic lock; but in a security mode (stated later) where locks are fastened to confine an intruder within a room, it transmits lock-fastening commands to all automatic locks. In case of infrared signals, when the system is designed to enable an automatic lock remote control key to send a light signal for a lock unfastening or fastening command and receive it and store the received infrared light pattern, it can be used for many purposes. This pattern storage method is publicly known and this type of learning remote control method is widely used.

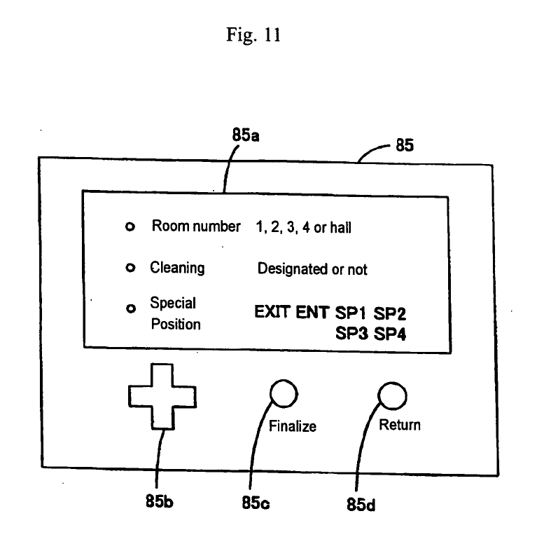

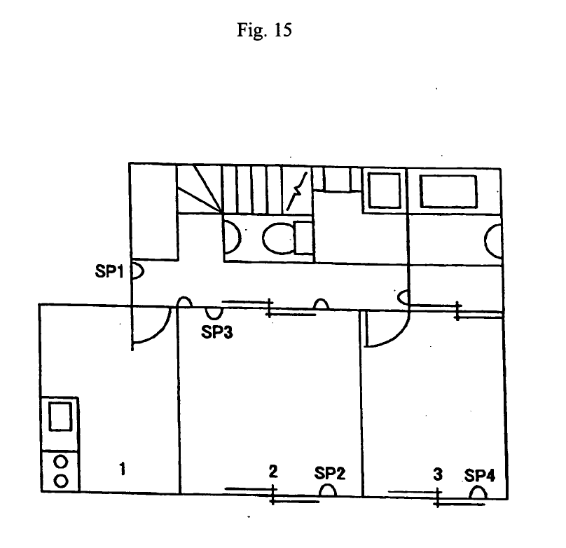

FIG. 11 shows the appearance of the marker 85 which has a liquid crystal display panel 85a, a cross key 85b, a Finalize key 85c and a Return key 85d on its external face. Inside it are a one-chip microcomputer, an infrared transmission/reception unit, a battery and so on. The one-chip microcomputer controls the display content on the liquid crystal display panel 85a according to the operation of the Finalize key 85c or Return key 85d and generates parameters in response to key operation to allow the infrared transmission/reception unit to output positional data depending on the parameters. In this embodiment, the following parameters are available: room numbers “1 to 7 and hall”; cleaning “designated (yes)” and “no”; and special positions “EXIT” (exit), “ENT” (entrance), “SP1” (special position 1), “SP2” (special position 2), “SP3” (special position 3), and “SP4” (special position 4). In the embodiment below, special position 1 represents the location of an automatic lock on a front door; special position 2 the location of an external window of room 2; special position 3 the location of an automatic lock on an inner door of room 2; and special position 4 the location of an automatic lock on an external window of room 3. A flowchart required to specify these parameters does not require special expertise and can be prepared by a person with ordinary knowledge in the art. FIG. 15 is a floor plan showing these special positions 1 to 4 in a house.

Next, how the above self-propelled cleaner works will be described.

(1) Traveling Control and Cleaning Operation

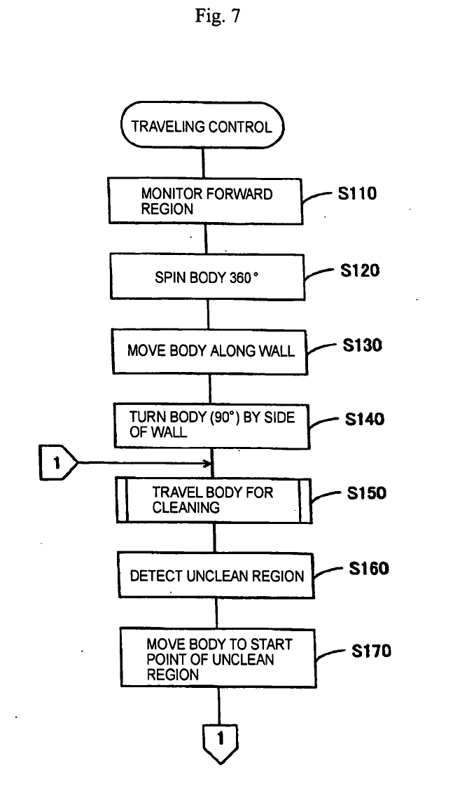

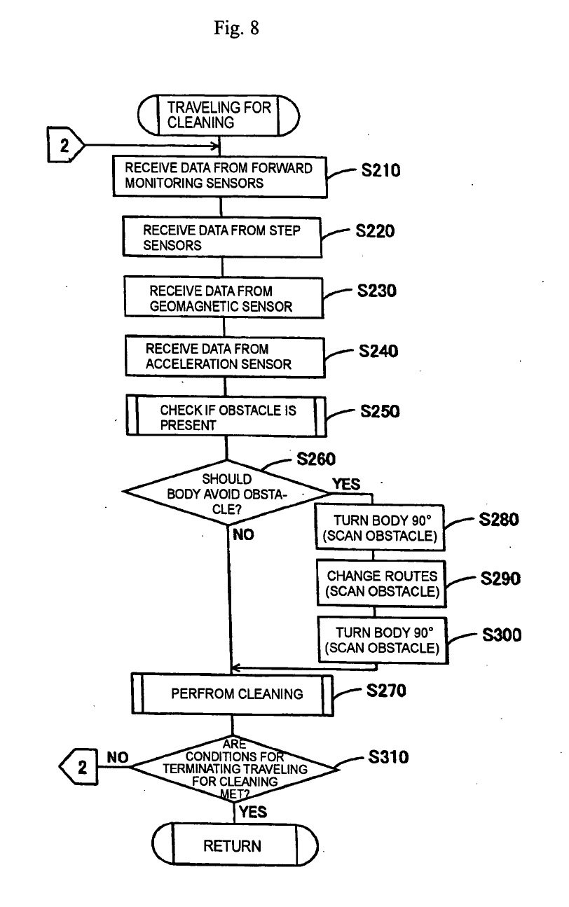

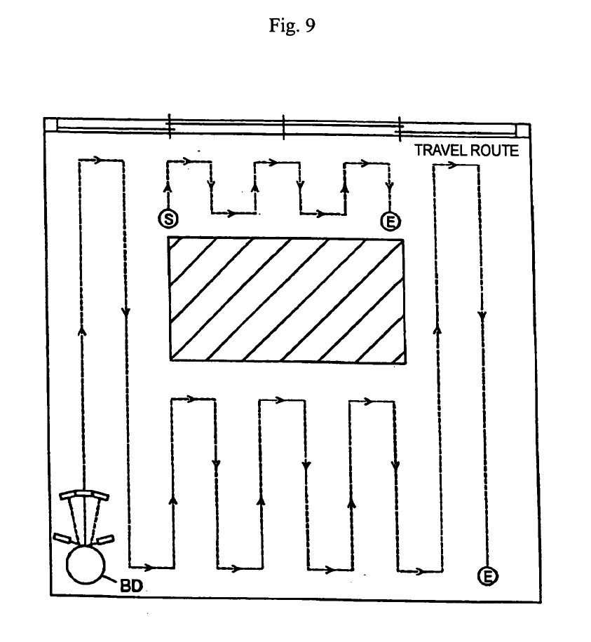

FIGS. 7 and 8 are flowcharts which correspond to a control program which is executed by the CPU 11; and FIG. 9 shows a travel route along which this self-propelled cleaner moves under the control program.

When the power is turned on, the CPU 11 begins to control traveling as shown in FIG. 7. At step S110, it receives the results of detection by the AF passive sensor unit 31 and monitors a forward region. In monitoring the forward region, reference is made to the results of detection by the AF passive sensors 31FR, 31EM and 31F; and if the floor surface is flat, the distance L1 to the floor surface (located downward in an oblique direction as shown in FIG. 4) is obtained from an image thus taken. Whether the floor surface in the forward region corresponding to the body width is flat or not is decided based on the results of detection by the AF passive sensors 31FR, 31FM and 31FL. However, at this moment, no information on the space between the body's immediate vicinity and the floor surface regions facing the AF passive sensors 31FR, 31FM and 31FL is not obtained so the space is a dead area.

At step S120, the CPU 11 orders the drive wheel motors 42R and 42L to rotate in different directions by equal amount through the motor drivers 41R and 41L respectively. As a consequence, the body begins turning on the spot. The rotation amount of the drive motors 42R and 42L required for 360-degree turn on the same spot (spin turn) is known and the CPU 11 informs the motor drivers 41R and 41L of that required rotation amount.

During this spin turn, the CPU 11 receives the results of detection by the AF passive sensors 31R and 31L and judges the condition of the immediate vicinity of the body. The above dead area is almost covered (eliminated) by the results of detection obtained during this spin turn, and if there is no step or obstacle there, it is confirmed that the surrounding floor surface is flat.

At step 130, the CPU 11 orders the drive wheel motors 42R and 42L to rotate by equal amount through the motor drivers 41R and 41L respectively. As a consequence, the body begins moving straight ahead. During this straight movement, the CPU 11 receives the results of detection by the AF passive sensors 31FR, 31FM and 3FL and the body advances while checking whether there is an obstacle ahead. The above dead area is almost covered by the detection made during this spin turn. When a wall surface as an obstacle ahead is detected, the body stops a prescribed distance short of the wall surface.

At step S140, the body turns clockwise by 90 degrees. The prescribed distance short of the wall at step S130 corresponds to a distance that the body can turn without colliding the wall surface and the AF passive sensors 31R and 31L can monitor their immediate vicinity and rightward and leftward regions beyond the body width. In other words, the distance should be such that when the body turns 90 degrees at step S140 after it stops according to the results of detection by the AF passive sensors 31FR, 31RM and 31FL at step S130, the AF passive sensor 31L can at least detect the position of the wall surface. Before it turns 90 degrees, the condition of its immediate vicinity should be judged according to the results of detection by the AF passive sensors 31R and 31L. FIG. 9 is a plan view which shows the cleaning start point (in the left bottom corner of the room as shown) which the body has thus reached.

There are various other methods of reaching the cleaning start point. If the body should turn only clockwise 90 degrees in contact with the wall surface, cleaning would begin midway on the first wall. If the body reaches the optimum position in the left bottom corner as shown in FIG. 9, it is also desirable to control its travel so that it turns counterclockwise 90 degrees in contact with the wall surface and advances until it touches the front wall surface, and upon touching the front wall surface, it turns 180 degrees.

At step S150, the body travels for cleaning. FIG. 8 is a flowchart which shows cleaning traveling steps in detail. Before advancing or moving forward, the CPU 11 receives the results of detection by various sensors at steps S210 to S240. At step S210, it receives forward monitoring sensor data (specifically the results of detection by the AF passive sensors 31FR, 31FM, 31FL and 31CL) which is used to judge whether or not there is an obstacle or wall surface ahead in the traveling area. Forward monitoring here includes monitoring of the ceiling in a broad sense.

At step S220, the CPU 11 receives step sensor data (specifically the results of detection by the AF passive sensors 31R and 31L) which is used to judge whether or not there is a step in the immediate vicinity of the body in the traveling area. Also, while the body moves along a wall surface or obstacle, the distance to the wall surface or obstacle is measured in order to judge whether or not it is moving in parallel with the wall surface or obstacle.

At step 230, the CPU 11 receives geomagnetic sensor data (specifically the result of detection by the geomagnetic sensor 43) which is used to judge whether or not there is any change in the traveling direction of the body which is moving straight. For example, the angle of geomagnetism at the cleaning start point is memorized and if an angle detected during traveling is different from the memorized angle, the amounts of rotation of the left and right drive wheel motors 42R and 42L are slightly differentiated to adjust the traveling direction to restore the original angle. If the angle becomes larger than the original angle of geomagnetism (change from 359 degrees to 0 degree is an exception), it is necessary to adjust the traveling direction to make it more leftward. Hence, an instruction is given to the motor drivers 41R and 41L to make the amount of rotation of the right drive wheel motor 42R slightly larger than that of the left drive wheel motor 42L.

At step S240, the CPU 11 receives acceleration sensor data (specifically the result of detection by the acceleration sensor 44) which is used to check the traveling condition. For example, if an acceleration in substantially one direction is sensed at the start of rectilinear traveling, the traveling is recognized to be normal. If an acceleration in a varying direction is sensed, an abnormality that one of the drive wheel motors is not driven is recognized. If a detected acceleration velocity is out of the normal range, a fall from a step or an overturn is suspected. If a considerable backward acceleration is detected, collision against an obstacle ahead is suspected. Although there is no direct acceleration control function (for example, a function to keep a desired acceleration velocity by input of an acceleration value or achieve a desired acceleration velocity based on integration), acceleration data is effectively used to detect an abnormality.

At step S250, the system checks whether there is an obstacle, according to the results of detection by the AF passive sensors 31FR, 31FM, 31CL, 31FL, 31R and 31L which the CPU 11 have received at steps S210 and S220. This check is made for each of the forward regions, ceiling and immediate vicinity. Here a forward region refers to an area ahead where detection is made for an obstacle or wall surface; and the immediate vicinity refers to an area where detection for a step is made and the condition of regions on the left and right of the body beyond the traveling width is checked (presence of a wall, etc). The ceiling here refers to an area where detection is made, for example, for a door lintel underneath the ceiling which leads to a hall and might cause the body to go out of the room.

At step S260, the system evaluates the results of detection by the sensors comprehensively to decide whether to avoid an obstacle or not. As far as there is no obstacle to be avoided, a cleaning process at step S270 is carried out. The cleaning process refers to a process that dust is sucked in while the side brushes and main brush are rotating. Concretely, an instruction is issued to the motor drivers 53R, 53L, 54 and 56 to drive the motors 51R, 51L, 52 and 55. Obviously the same instruction is always given during traveling and when the conditions to terminate traveling for cleaning are met, the body stops traveling.

On the other hand, if it is decided that the body must avoid an obstacle (do escape motion), it turns clockwise 90 degrees at step S280. This is a 90-degree turn on the same spot which is achieved by giving an instruction to the drive wheel motors 42R and 42L through the motor drivers 41R and 41L respectively to turn them in different directions by the amount necessary for the 90-degree turn. Here, the right drive wheel should turn backward and the left drive wheel should turn forward. During the turn, the CPU 11 receives the results of detection by the AF passive sensors 31R and 31L as step sensors and checks for an obstacle. When an obstacle ahead is detected and the body turns clockwise 90 degrees, if the AF passive sensor 31R does not detect a wall ahead on the right in the immediate vicinity, it may be considered to have simply touched a forward wall, but if a wall surface ahead on the right in the immediate vicinity is still detected even after the turn, the body may be considered to get caught in a corner. If neither of the AF passive sensors 31R and 31L detects an obstacle ahead in the immediate vicinity during 90-degree turn, it can be thought that the body has not touched a wall but there is a small obstacle.

At step S290, the body advances to change routes or turn while scanning for an obstacle. It touches the wall surface and turns clockwise 90 degrees, then advances. If it has stopped short of the wall, the distance of the advance is almost equal to the body width. After advance by that distance, the body turns clockwise 90 degrees again at step S300.

During the above movement, the forward region and leftward and rightward regions ahead are always scanned for an obstacle and the result of this monitoring scan is memorized as information on the presence of an obstacle in the room.

As explained above, a 90-degree clockwise turn is made twice. If the body should turn clockwise 90 degrees upon detection of a next wall ahead, it would return to its original position. Therefore, after it turns clockwise 90 degrees twice, it should turn counterclockwise twice and then clockwise twice, namely in alternate directions. This means that it should turn clockwise at an odd-numbered time of escape motion and counterclockwise at an even-numbered time of escape motion.

The system continues traveling for cleaning while scanning the room in a zigzag pattern and avoiding an obstacle as described so far. Then at step S310, whether or not it has reached the end of the room is decided. After the second turn, if the body has advanced along the wall and has detected an obstacle ahead, or if it has entered a region where it already traveled, it is decided that the body has reached the cleaning traveling termination point. In other words, the former situation can occur after the last end-to-end travel in the zigzag movement; and the latter situation can occur when a region left unclean is found and cleaning traveling is started again.

If either of these conditions is not met, the system goes back to step S210 and repeats the abovementioned steps. If either of the conditions is met, the system finishes the cleaning traveling subroutine and returns to the process of FIG. 7.

After returning to the process of FIG. 7, at step S160, the system judges from the collected information on the traveled regions and their surroundings as to whether or not there is any region left unclean. If an unclean region is found, the body moves to the start point of the unclean region at step S170 and the system returns to step S150 and starts cleaning traveling again.

Even if there are more than one unclean region here and there, each time the conditions to terminate traveling for cleaning are met, detection for an unclean region is repeated as described above until there is no unclean region.

(2) Mapping

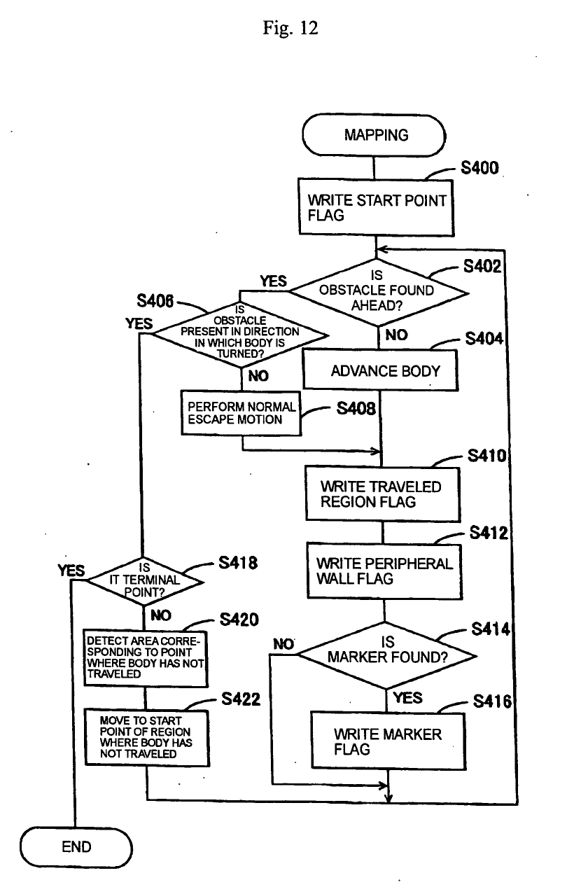

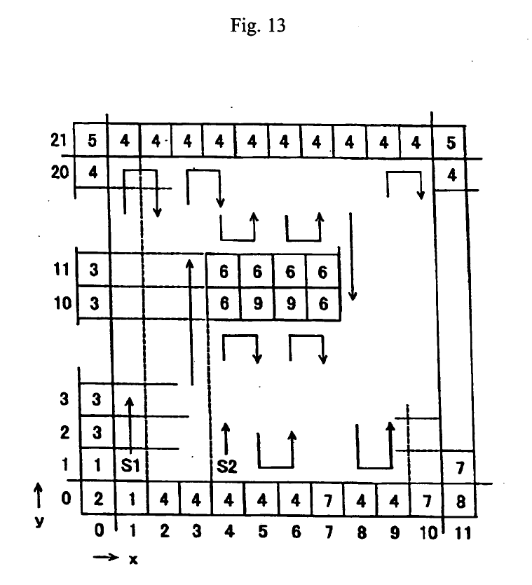

Various methods of detection for an unclean region are available. This embodiment adopts a method as illustrated in FIGS. 12 and 13.

FIG. 12 is a flowchart of mapping and FIG. 13 illustrates a mapping method. In this example, based on the abovementioned rotary encoder detection results, the travel route in the room and information on wall surfaces detected during traveling are written in a map reserved in a memory area. The presence of an unclean region is determined from the map by checking whether or not, in the map, the surrounding wall surface is continuous and the perimeters of obstacles in the room are all continuous and the body has traveled across all regions of the room except the obstacles.

The mapping database is a two-dimensional database which allows an address to be expressed as (x,y) where (1, 1) denotes the start point region in a corner of the room and (n, 0) and (0, m) denote regions of hypothetical wall surfaces. As the body travels, the room is mapped by categorizing its regions into several groups: untraveled regions, cleaned regions, walls and obstacles where each region is a unit area whose dimensions are equal to the body's dimensions, or 30 cm×30 cm.

At step S400, a start point flag is written. The start point (1, 1) is a corner of the room as shown in FIG. 13. The cleaner body turns 360 degrees (spin turn) to confirm that there is a wall surface behind and on the left of it; and the system writes a wall flag [1] for unit areas (1,0) and (0,1) and writes a wall flag [2] for an intersection of walls (0,0). At step S402, the system checks whether or not there is an obstacle ahead and at step S404 and the body advances by the distance equivalent to a unit area. This advance involves cleaning as mentioned above. Concretely, when the cleaner body has moved by the distance equivalent to a unit area as indicated by rotary encoder output during cleaning traveling, this mapping process is performed synchronously and concurrently.

On the other hand, if it is decided that there is an obstacle ahead, whether there is an obstacle in the direction in which the body turns is checked at step S406. The body escapes from the obstacle by a combination of a 90-degree turn, an advance and a 90-degree turn. The direction of turn is alternately changed every two turns (two clockwise turns, then two counterclockwise turns). If the next turn for escape should be clockwise and there is an obstacle ahead, whether or not the body can go rightward and turn is judged. In the early stage of cleaning, on the assumption that the rightward region is unclean and there is no obstacle in the direction in which the body turns, normal escape motion is done at step S408.

After the above movements, at step S410, a traveled region flag is written for each unit area where the body has traveled. Since a region where the body has traveled (traveled region) is considered to be a region which has been cleaned, a flag which represents a cleaned region is written for it. At step S412, a peripheral wall flag which represents the condition of a peripheral wall is written for each unit area. When the body moves from unit area (1,1) to unit area (1,2), it is possible to judge whether unit areas (0,1) and (2,1) are a wall or not according to the results of detection by the AF passive sensors 31R and 31L. A flag which represents a wall is written for unit area (0,1) and a flag which represents the absence of a wall and an untraveled/unclean region is written for unit area (2,1).

In this example, an obstacle ahead is detected at the point of unit area (1,20) and the body moves to unit area (2,20) by two 90-degree turns and an advance while the traveling direction is changed 180 degrees. At this time, a flag [4] is written for each of unit areas (0,20), (2,20), (1,21) and (2,21). For unit area (0,21), a flag which represents a wall [5] is written based on the judgment that it is an intersection of walls (a point where walls meet). A traveled/cleaned region is also treated as an obstacle.

As the body advances, an obstacle on the right is detected at the positions of unit areas (3,10) and (3,11) and a flag for an obstacle [6] is written. While the body moves across unit areas (3,1) to (3,9), untraveled/unclean regions ahead on the right are detected and a corresponding flag is written for them. Similarly, when the body moves across unit areas (8,9) to (8,1) later, untraveled/unclean regions ahead on the right are detected and a corresponding flag is written for them.

When the body is at the point of unit area (4,12), an obstacle ahead is detected and an escape motion is done. Here, an obstacle flag has been written for unit area (4,11) and as it moves, an obstacle flag is written for unit area (4,11).

At step S414, whether or not there has been communication of positional data with the marker 85 is judged at the point of each traveled unit area; if there has been communication with the marker 85, a flag based on the marker information is written at step S416. For example, if the user has specified a particular unit area for an escape gate using operation keys 85b to 85d of the marker 85, as the body passes the unit area, the infrared communication unit 83 acquires that positional data and a flag representing an escape gate is written for that unit area.

After repeated advance and escape motions, an obstacle ahead on the left is detected at the point of unit area (10,20). In this case, unit area (10,20) is judged as part of a continuous wall and a wall flag [4] is also written for unit area (11, 20) and a wall intersection flag [5] is written for unit area (11, 21).

As a result of repeated advance and escape motions, an obstacle ahead is detected at the point of unit area (10,1) and an obstacle in the direction in which the cleaner body turns is also detected. Hence, whether the travel termination point is reached or not is judged at step S418. At the position of unit area (10,1), an obstacle ahead and a wall on the left in the traveling direction are detected [7] [8].

A primary factor which determines whether the travel termination point has been reached or not is the presence or absence of a unit area for which an “untraveled/unclean” region flag is written. If there is no unit area for which an untraveled/unclean region flag is written, whether or not the wall flag written at the start point is continuously repeated to go round the room is checked. If so, the room is scanned in both the X and Y directions to check for a region for which no flag is written. Unit areas for which an obstacle flag is written are considered as a continuous area like a wall and obstacle detection is thus finished.

If the cleaning traveling termination point has not been reached, an untraveled region is detected at step S420 and the body moves to the start point of that untraveled region at step S422 and the above process is repeated. When it is finally decided that the cleaning traveling termination point has been reached, mapping is completed. Upon completion of mapping, the walls and traveled regions of the room are clearly indicated and this is used as map information.

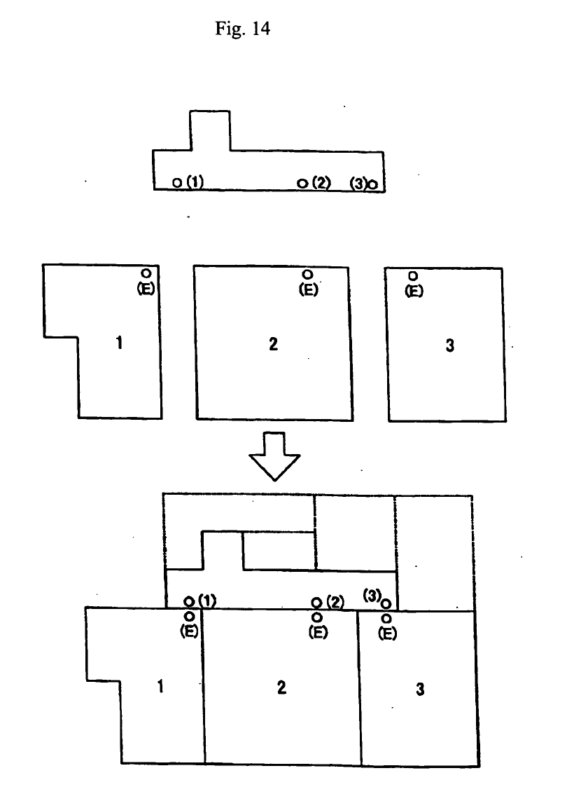

All rooms and a hall should be mapped with the abovementioned procedure and entrances to rooms in halls should be marked via the marker 85. FIG. 14 shows a method of joining pieces of map information on the rooms and hall. All the rooms are numbered (1-3), the doorways of the rooms are marked with E and the entrances of the rooms from the hall are numbered (1-3) so that the pieces of map information on the rooms are joined on a planar basis.

(3) Lock Fastening/Unfastening Control Process

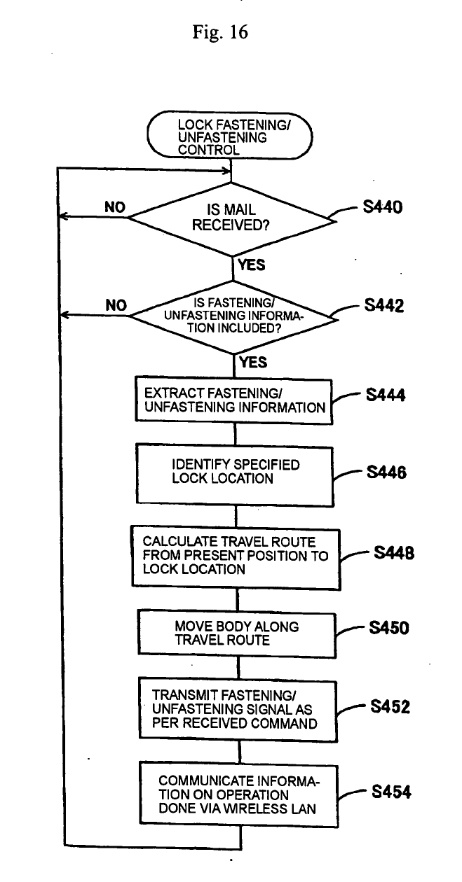

FIG. 16 shows a process of fastening or unfastening a lock. This process is carried out when the lock fastening/unfastening function is enabled by remote control according to an instruction from the operation panel unit 15. This process is started at each predetermined time set on a timer (not shown). At step S440, the system judges whether it has received a mail or not. If not, the system enters the standby state again. Even if it has received a mail, when it is decided at step S442 that the mail does not include lock fastening/unfastening information, it reenters the standby state. An alternative approach is to arrange that this lock fastening/unfastening control process is carried out at the same time when the system receives a mail.

At step S444, the system extracts lock fastening/unfastening information from the mail. The lock fastening/unfastening information in the mail is a command to identify an automatic lock and specify whether to fasten or unfasten it. Alternatively it may be a command to ask the automatic lock about its state. However, considering that this type of question is often asked when the user cannot remember whether he/she fastened the lock or not, in most cases it will be enough to send a lock fastening command to fasten the lock instead of a command to inquire about the state of the lock. However, when the infrared communication unit 83 can receive, from an automatic lock, an infrared signal which indicates the state of the lock, it may be used as follows. The unit sends a command to make the automatic lock transmit a signal indicating its state in response to the inquiry mail and receives the transmitted infrared signal, detects the state and sends an answer by mail.

At step S446, based on information on an automatic lock as specified by mail, its position in the room as included in the map information is identified. The location of the automatic lock is identified with a marker 85. Therefore, if the automatic lock on the front door is specified by mail, its position is identified as special position 1; if the one on the external window of room 2 is specified, its position is identified as special position 2; if the one on the inner door of room 2 is specified, its position is identified as special position 3; and if the one on the external window of room 3 is specified, its position is identified as special position 4. The location of an automatic lock may be specified directly by mail or as one of special positions 1 to 4 identified with markers 85.

At step S448, the system calculates a travel route from the present position to the location thus specified. When map information is completed as described earlier, it is possible to find the travel route from the present position to the specified location. To obtain the travel route, a known labyrinth solution method may be used. For example, according to the right hand method, when you advance with your hand always on a wall surface along the advance direction, you can finally reach from the entrance to the goal. Then, redundant paths are deleted sequentially. For example, return paths after 180-degree turns are deleted sequentially. Also, a region of U turn is found and regions as a return path after the U turn are skipped unless there is an obstacle. Instead of an automatic travel route calculation like this, an interface which shows the user a travel route may be provided.

After the travel route from the present position to the location of the automatic lock is calculated in this way, the body moves along the travel route at step S450.

After completion of the movement, at step S452 the remote operation signal transmission circuit 84 transmits a lock fastening/unfastening signal as specified by mail to the automatic lock.

Although the user away from home can easily order the system to fasten a lock, he/she may feel uncertain that the lock has been actually fastened. Also, though the user has intended to lock the automatic lock on the front door, he/she may wonder if he/she ordered the system to lock an automatic lock for a room adjacent to the front door by mistake. Therefore, in this embodiment, at step S454 the system gives the user, through a wireless LAN, information on what operation has been done. Concretely, the information include the location of an automatic lock concerned, whether the transmitted signal has been a command for either fastening or unfastening the lock, and time of signal transmission. When information on the state of the automatic lock can be obtained from the lock as described above, the system can make the remote operation signal transmission circuit 84 send a signal which indicates the state of the lock and make the infrared communication unit 83 receive this signal to know the state of the lock and generate information on the state of the lock as mentioned above. Needless to say, it is more desirable to receive a state signal received from the automatic lock and add it as state information because it better reflects the actual state of the lock. In this embodiment, even when the automatic lock cannot notify of its state, the CMOS cameras 61 and 62 of the camera system unit 60 may be used to take a photo of the automatic lock and the photo image data may be attached to an e-mail. A person who has received the mail can see the image and confirm the state of the lock.

After this, the system returns to step S440 and repeats the same steps as described above.

A single mail can order the system to fasten or unfasten plural automatic locks. In this case, when the system extracts lock fastening/unfastening information at step S444, it divides the information into pieces of information for individual automatic locks and repeats steps S448 to S454 for each automatic lock.

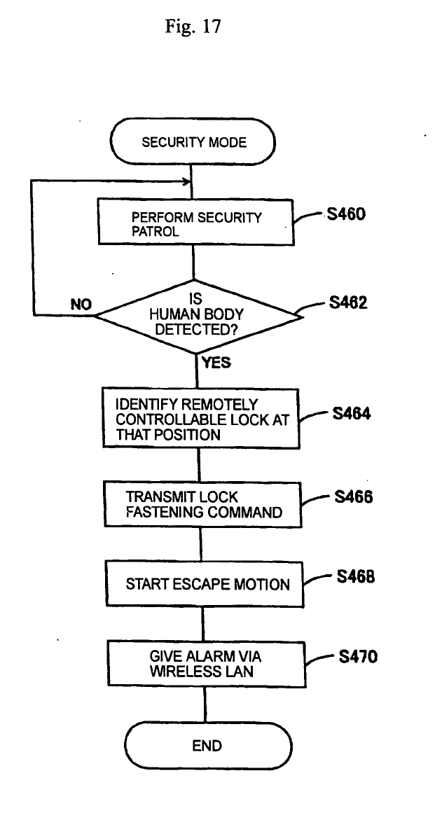

FIG. 17 is a flowchart showing a security mode process.

(4) Security Mode Process

This self-propelled cleaner can be used to provide security by utilizing its functions. In the security mode where a security process is carried out, the cleaner travels along a preset patrol route at step S460. For example, it goes round to various places in the following order: hall, room 1, hall, room 2, hall, room 3, hall, room 1 and so on. During this patrol, the system acquires information on the status of each of the human sensors 21fr, 21rr, 21fl, and 21rl and if it finds any change in the status, it suspects the presence of a human body ahead.

If there is no intruder, the system detects no human body and repeats steps S460 and S462. If an intruder enters a room during the patrol, the human sensor unit 21 detects the human body at step S462.

Upon detection of the human body, the system identifies a remotely controllable lock installed there according to the present position information (step S464). For example, if the self-propelled cleaner is in room 2, the automatic lock on the external window of room 2 and the one on the inner door are identified. Geographical information on each room is obtained by mapping and data on the above special positions 1 to 4 are stored in relation to the individual rooms; therefore, by recognizing which room the cleaner is in, the relevant automatic lock(s) can be identified.

At step S466, a lock fastening command is sent. If the cleaner is in room 2, the remote operation signal transmission circuit 84 sends signals to fasten the automatic locks as identified in relation to special positions 2 and 3. When the automatic locks in room 2 are fastened, the intruder will be encaged in room 2. So a guard or the police may be called to hand over the intruder to the guard or police.

At step S468, the cleaner begins an escape motion and, at step S470, gives an alarm to the user outside through a wireless LAN by e-mail.

The escape motion is a motion which prevents an attempt to destroy the self-propelled cleaner by an intruder who has found it. During the escape motion, the system can prepare for the next step of giving an alarm (step S470). The escape motion may consist of a predetermined combination of linear moves and curvilinear moves or may be such that, according to the map information, the cleaner rushes toward an area where it can move safely, in a direction opposite to the direction of the intruder as detected by the human sensor unit 21. When an alarm is given through a wireless LAN, the alarm message will include the following information: the fact that the intruder has been detected; the room where the intruder has been detected; the location of the fastened automatic lock; and present time. In this case, the system may be programmed so that a photo of the surroundings is taken by the camera system unit 60 and the photo image data is attached to an e-mail.

If the system works as described above, the user away from home can receive the e-mail via his/her mobile phone, know what is happening and if the image data file is attached, grasp the situation concretely and take necessary measures (for example, call a security company or the police to have them rush to the scene).

If an intruder is detected in the security mode, the system no longer continues patrolling and ends the security mode. However, it is also possible to arrange that if the system gives an alarm to the user at step S470 and the user receives it and considers it an operational error, the user can send an instruction to cancel the alarm by e-mail. Upon receipt of a mail containing a cancellation instruction, the system may unfasten the lock once fastened and restart patrolling.

As described so far, while traveling around a room for cleaning, the cleaner generates map information (steps S400 to 422) and, in the vicinity of a marker 85, adds positional data from the marker to the map information. The markers 85 identify the locations of automatic locks as special positions 1 to 4 so that positional data on the locations of the automatic locks are included in the map information very easily. In the lock fastening/unfastening control process, the system judges whether a lock fastening/unfastening instruction has been received or not (steps S440 and S442) and extracts lock fastening/unfastening information (step S444) and moves along the travel route to a specified lock location (step S450) and sends a lock fastening/unfastening signal in response to the received instruction (step S452). In this way, the system makes it very easy for the user outside to specify the location of an automatic lock and give an instruction to fasten or unfasten the lock.

1. A self-propelled cleaner having a body with a cleaning mechanism and a drive mechanism with drive wheels at the left and right sides of the body whose rotation can be individually controlled for steering and driving the cleaner, comprising:
a mapping processor which acquires and stores map information on a room to be cleaned during traveling around the room for cleaning it and acquires positional data on the location of a remotely controllable lock from a marker installed in a given place in the room which outputs positional data on a previously specified location, and adds it to the map information;
a wireless LAN communication device which can transmit given information to the outside and receive given information from the outside through a wireless LAN;
a remote control processor which can transmit remote operation signals to remotely controllable locks, installed on a front door, an external window and an inner door as special positions stored in the mapping processor through the marker, which can be fastened or unfastened according to the remote operation signals;
a travel route calculation processor which calculates a travel route from the present position to the above specified locations; and
a lock fastening/unfastening control processor which, upon receipt of a lock fastening/unfastening command for the remotely controllable locks from outside through the wireless LAN, makes the travel route calculation processor calculate a travel route and controls the drive mechanism so as to move the cleaner along the travel route, and makes the remote control processor transmit a received lock fastening/unfastening remote operation signal at the specified location.

2. A self-propelled cleaner having a body with a cleaning mechanism, and a drive mechanism capable of steering and driving the cleaner, comprising:
a mapping processor which generates and stores map information on a room during traveling around the room by self-propulsion, and acquires, from a marker installed in a given place in the room which outputs positional data on a previously specified location, the positional data and adds it to the map information;
a wireless LAN communication device which can transmit given information to the outside and receive given information from the outside through a wireless LAN;
a remote control processor which can transmit a remote operation signal to a remotely controllable lock which is installed at the location specified by the positional data from the marker and can be fastened or unfastened according to the remote operation signal;
a travel route calculation processor which calculates a travel route from the present position to the above specified location; and
a lock fastening/unfastening control processor which, upon receipt of a lock fastening/unfastening command for the remotely controllable lock from outside through the wireless LAN, makes the travel route calculation processor calculate a travel route and controls the drive mechanism so as to move the cleaner along the travel route, and makes the remote control processor transmit a received lock fastening/unfastening remote operation signal at the specified location.

3. The self-propelled cleaner as described in claim 2, wherein the remotely controllable lock is a front door lock and the marker is located on a front door and outputs positional data as a position for fastening or unfastening the lock, and the lock fastening/unfastening control processor makes the remote control processor fasten or unfasten the front door lock.

4. The self-propelled cleaner as described in claim 2, wherein the remotely controllable lock is an external window lock and the marker is located on an external window and outputs positional data as a position for fastening or unfastening the lock, and the lock fastening/unfastening control processor makes the remote control processor fasten or unfasten the external window lock.

5. The self-propelled cleaner as described in claim 2, wherein the remotely controllable lock is installed on each of an external window and an inner door in a given room and the lock fastening/unfastening control processor, upon detection of an intruder in the room, fastens the remotely controllable locks to lock the external window and inner door.

6. The self-propelled cleaner as described in claim 5, wherein the lock fastening/unfastening control processor can control the drive mechanism so as for the cleaner to perform a predetermined escape motion.

7. The self-propelled cleaner as described in claim 2, wherein the lock fastening/unfastening control processor gives information on operations done to a previously specified person through a wireless LAN.

8. The self-propelled cleaner as described in claim 7, wherein the information on operations done includes the location of an automatic lock, whether either a lock fastening signal or a lock unfastening signal was transmitted to the automatic lock, and time of transmission of the signal.

9. The self-propelled cleaner as described in claim 2, wherein it has a camera unit capable of taking a photo of an automatic lock and outputting photo image data and the lock fastening/unfastening control process or enables the camera unit to take a photo of an automatic lock and attaches that photo image data to an e-mail to send it to a predetermined person through a wireless LAN.
